(19) United States
(12) Patent Application Publication
(10) Pub. No.: US 2007/0121043 A1
(43) Pub. Date: May 31, 2007

(54) Liquid crystal display device

(76) Inventor: Sung Hoon Moon, Ulsan (KR)

Correspondence Address: CHRISTIE, PARKER & HALE, LLP, PO BOX 7068, PASADENA, CA, 91109-7068, US

(21) Appl. No.: 11/523,967

(22) Filed: Sep. 19, 2006

(30) Foreign Application Priority Data
Nov. 30, 2005 (KR) 10-2005-00115970

(51) Int. Cl. G02F 1/1335

(52) U.S. Cl. 349/117

(57) ABSTRACT

A liquid crystal display device prevents an occurrence of a remaining retardation in an electrically controlled birefringence (ECB) mode liquid crystal panel by attaching first and second polarizing plates to upper and lower sides of the liquid crystal panel, and by forming an optical viewing angle compensation film between the first and/or second polarizing plates. In one embodiment, the ECB mode liquid crystal panel includes first and second substrates, first and second orientation films respectively being at the first and second substrates and oriented opposite to each other, and a liquid crystal layer formed between the first and second substrates. A first polarizing plate is formed at an outer surface of the first substrate. A second polarizing plate is formed at an outer surface of the second substrate. A compensation film is formed between the panel and the first polarizing plate, and/or between the panel and the second polarizing plate.

### CROSS-REFERENCE TO RELATED APPLICATION

This application claims priority to and the benefit of Korean Patent Application No. 10-2005-00115970, filed on Nov. 30, 2005, in the Korean Intellectual Property Office, the entire content of which is incorporated herein by reference.

### BACKGROUND

1. Field of the Invention

The present invention relates to a liquid crystal display device, and, more particularly, to an electrically birefringence (ECB) mode transmissive type liquid crystal display device.

2. Discussion of Related Art

A liquid crystal display device can be classified into a twisted nematic (TN) type, an electrically birefringence (ECB) type, and an optically compensated birefringence (OCB) type, according to an operation mode. Further, the liquid crystal display device can be classified into a transmissive type liquid crystal display device and a reflective type liquid crystal display device according to the kind of a light source. The transmissive type liquid crystal display device uses internal light source such as backlight to display an image, and the reflective type liquid crystal display device uses external light source such as a natural sunlight.

Recently, a need has been developed that requires the advantages of a transmissive type liquid crystal display device and a reflective type liquid crystal display device. Under this circumstance, a transflective type liquid crystal display device has been proposed to have the advantages of both the transmissive type liquid crystal display device and the reflective type liquid crystal display device. The transflective type liquid crystal display device in general includes an ECB mode liquid crystal panel.

FIG. 1 is a schematic cross-sectional view showing a conventional transflective type liquid crystal display device.

As shown in FIG. 1, the conventional transflective type liquid crystal display device includes an electrically controlled birefringence (referred to as ‘ECB’ hereinafter) mode liquid crystal panel 100, a first retardation film 110, a first polarizing plate 120, a second retardation film 130, and a second polarizing plate 140. The ECB mode liquid crystal panel 100 drives a liquid crystal cell, and includes first and second substrates 102 and 104, first and second orientation films 103 and 105 respectively being at the first and second substrates 102 and 104 and oriented opposite to each other, and a liquid crystal 107 formed between the first and second substrates 102 and 104. The first retardation film 110 is formed at an outer surface of the first substrate 102. The first polarizing plate 120 is formed at an outer surface of the first retardation film 110. The second retardation film 130 is formed at an outer surface of the second substrate 104. The second polarizing plate 140 is formed at an outer surface of the second retardation film 130.

Here, the first and second retardation films 110 and 130 function to change a polarized state of a light. For example, a λ/4 retardation plate for changing a light in a line polarization into a circle polarization may be used as the first and second retardation films 110 and 130. Also, a λ/2 retardation plate for rotating a light in a line polarization or a circle polarization at a predetermined angle may be used as the first and second retardation films 110 and 130. The λ/4 retardation plate and the λ/2 retardation plate can be simultaneously used as the first and second retardation films 110 and 130.

Furthermore, the first and second polarizing plates 120 and 140 are arranged at outer surfaces of the first and second retardation films 110 and 130, respectively. A light transmittance axis of the first polarizing plate 120 forms an angle of 90° with respect to a light transmittance axis of the second polarizing plate 140.

Moreover, a backlight (not shown) is arranged at an outer surface of the second polarizing plate 140, namely, at a lower portion of (or below) the second polarizing plate 140.

However, in the conventional ECB mode transflective type liquid crystal display device, as shown in FIG. 1, retardation films and polarizing plates are arranged at upper and lower sides of an ECB mode liquid crystal panel, thereby greatly increasing a thickness thereof.

In addition, so as to embody a transmissive type liquid crystal display device using the ECB mode liquid crystal panel, when only polarizing plates included in the aforementioned transflective type liquid crystal display device are formed on the liquid crystal panel, a remaining retardation occurs in the ECB mode liquid crystal panel, with the result that a display in a dark state becomes impossible.

### SUMMARY OF THE INVENTION

Accordingly, it is an aspect of the present invention to provide a liquid crystal display device that prevents an occurrence of a remaining retardation in an ECB mode liquid crystal panel by attaching first and second polarizing plates to upper and lower sides of the ECB mode liquid crystal panel, and by forming an optical viewing angle compensation film between the first and/or second polarizing plates.

An embodiment of the present invention provides a liquid crystal display device having: an electrically controlled birefringence mode liquid crystal panel for driving a liquid crystal cell and including first and second substrates, first and second orientation films respectively being at the first and second substrates and oriented opposite to each other, and a liquid crystal layer formed between the first and second substrates; a first polarizing plate formed at an outer surface of the first substrate; a second polarizing plate formed at an outer surface of the second substrate; and a compensation film formed between the electrically controlled birefringence mode liquid crystal panel and the first polarizing plate, and/or between the electrically controlled birefringence mode liquid crystal panel and the second polarizing plate.

An embodiment of the present invention provides a liquid crystal display device having: an electrically controlled birefringence mode liquid crystal panel including first and second substrates, first and second orientation films respectively being at the first and second substrates and oriented opposite to each other, and a liquid crystal layer formed between the first and second substrates; a first polarizing plate formed at an outer surface of the first substrate; a second polarizing plate formed at an outer surface of the second substrate; and a compensation film formed between the electrically controlled birefringence mode liquid crystal panel and the first polarizing plate.

In one embodiment, the compensation film is composed of an optical viewing angle compensation film or a retardation film.

Also, a light transmittance axis of the first polarizing plate and a light transmittance axis of the second polarizing plate are inclined by about 35° to 55°, or by about 45° with respect to an orientation direction of the liquid crystal layer included in the electrically controlled birefringence mode liquid crystal panel.

Further, the light transmittance axis of the first polarizing plate and the light transmittance axis of the second polarizing plate have an angle from about 80° to 100° with respect to each other, or are arranged orthogonal to each other.

Moreover, a negative retardation of the compensation film ranges from about −60 nm to −10 nm, or is about −35 nm.

Furthermore, an optical axis of the optical viewing angle compensation film is arranged horizontal to an orientation direction of the liquid crystal layer included in the electrically controlled birefringence mode liquid crystal panel.

In addition, an optical axis of the optical viewing angle compensation film is inclined by about −10° to 10° with respect to an orientation direction of the liquid crystal layer included in the electrically controlled birefringence mode liquid crystal panel, and an optical axis of the retardation film is inclined by about 80° to 100° with respect to an orientation direction of the liquid crystal layer included in the electrically controlled birefringence mode liquid crystal panel.

Also, an optical axis of the compensation film and a light transmittance axis of the first and/or second polarizing plate facing the compensation film are arranged to have an angle from about 35° to 55° with respect to each other.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic cross-sectional view showing a conventional transflective type liquid crystal display device;

FIG. 2 is a cross-sectional view showing a liquid crystal display device according to an embodiment of the present invention;

FIG. 3 is cross-sectional view showing a liquid crystal display device according to another embodiment of the present invention; and

FIG. 4 is a view showing an internal construction of an optical viewing angle compensation film included in a liquid crystal display device according to an embodiment of the present invention.

### DETAILED DESCRIPTION

In the following detailed description, certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. There may be parts shown in the drawings, or parts not shown in the drawings, that are not discussed in the specification as they are not essential to a complete understanding of the invention. Like reference numerals designate like elements. Here, when a first element is connected to/with a second element, the first element may be not only directly connected to/with the second element but also indirectly connected to/with the second element via a third element.

FIG. 2 is a cross-sectional view showing a liquid crystal display device according to an embodiment of the present invention.

With reference to FIG. 2, the liquid crystal display device according to an embodiment of the present invention includes an ECB mode liquid crystal panel, a first polarizing plate 70, a second polarizing plate 80, and a compensation film (e.g., an optical viewing angle compensation film) 90. The ECB mode liquid crystal panel drives a liquid crystal cell. The ECB mode liquid crystal panel includes first and second substrates 50 and 10, first and second orientation films 42 and 44 respectively being at the first and second substrates 50 and 10 and oriented opposite to each other, and a liquid crystal layer 40 formed between first and second substrates 50 and 10. The first polarizing plate 70 is formed at an outer surface of the first substrate 50. The second polarizing plate 80 is formed at an outer surface of the second substrate 10. The optical viewing angle compensation film 90 is formed between the ECB mode liquid crystal panel and the first polarizing plate 70.

Here, the first substrate 50 and the second substrate 10 are arranged at the ECB mode liquid crystal panel. A thin film transistor Tr is formed on the second substrate 10, and is composed of a gate electrode 13 and source and drain electrodes 23a and 23b. The thin film transistor Tr further includes an active layer 19 and an ohmic contact layer 20. A gate insulation film 16 is formed at an upper portion of the gate electrode 13.

A passivation layer 25 is formed at an upper portion of the thin film transistor Tr and covers the thin film transistor Tr. The passivation layer 25 includes a contact hole 27 to expose the drain electrode 23b. Then, a pixel electrode 36 is formed at an upper portion of the passivation layer 25, and is connected to the drain electrode 23b via the contact hole 27.

In addition, black matrixes 53 are formed on an inner surface of the first substrate 50 at a location corresponding to the thin film transistor Tr (i.e., in FIG. 2 at least one of the black matrixes 53 is shown to be formed at a location corresponding to the thin film transistor Tr). Color filter patterns 56a, 56b, and 56c have red, green, and blue filters arranged repeatedly between the black matrixes 53. At lower portions of the color filter patterns 56a, 56b, and 56c, an overcoat layer 60 and a common electrode 63 are successively formed. The common electrode 63 is made of transparent conductive materials. Herein, one color of the color filter patterns 56a, 56b, and 56c corresponds to one pixel electrode 36.

Moreover, the first and second orientation films 42 and 44 are formed at inner surfaces of the first and second substrates 50 and 10, respectively. The first and second orientation films 42 and 44 are oriented in directions opposite to each other.

The liquid crystal layer 40 is injected between the first and second orientation films 42 and 44. When a voltage is applied to the pixel electrode 36 and the common electrode 63, liquid crystal molecules of the liquid crystal layer 40 horizontally oriented by the first and second orientation films 42 and 44 are changed in an aligned state by an electric field generated between the pixel and common electrodes 36 and 63, with the result that the liquid crystal display device is driven.

In addition, as a transmissive type liquid crystal display device, the liquid crystal display device needs an additional light source. Although it is not shown, a backlight is arranged at a lower portion of (or below) the second polarizing plate 80 as the additional light source, and light from the backlight is incident onto the liquid crystal panel to adjust an amount of the light according to an alignment of the liquid crystal molecules so that an image is displayed.

That is, the ECB mode liquid crystal panel according to an embodiment of the present invention is characterized in that orientation films 42 and 44 are respectively on the first and second substrates 50 and 10 and oriented opposite to each other, and the liquid crystal layer 40 is horizontally oriented by the orientation films 42 and 44 formed between the first and second substrates 50 and 10, so that the liquid crystal cell is driven.

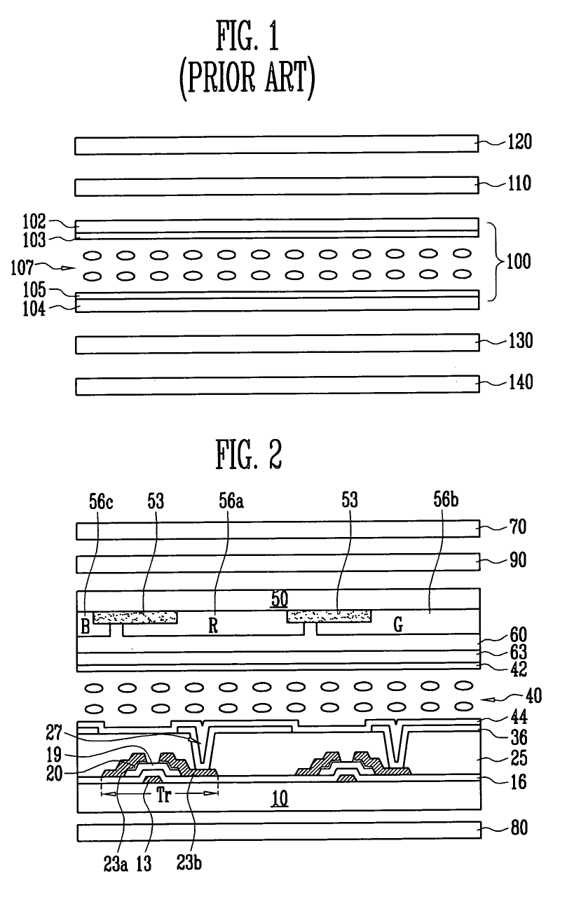

In a liquid crystal display device, e.g., as illustrated earlier in FIG. 1, an ECB mode liquid crystal panel is in general included in a transflective liquid crystal display device. However, the liquid crystal display device is characterized in that a transmissive type liquid crystal display device is also embodied through the ECB mode liquid crystal panel.

So as to do this (e.g., to embody the transmissive type liquid crystal display device through the ECB mode liquid crystal panel), first and second polarizing plates 70 and 80 are provided at upper and lower sides of the ECB mode liquid crystal panel in FIG. 2. The compensation film 90 is formed between the ECB mode liquid crystal panel and the first polarizing plate 70. Through the aforementioned arrangement, a remaining retardation of the ECB mode liquid crystal panel is prevented so as to improve a contrast and a viewing angle.

Here, the compensation film 90 can be composed of an optical viewing angle compensation film or a retardation film.

Furthermore, a light transmittance axis of the first polarizing plate 70 and a light transmittance axis of the second polarizing plate 80 are inclined by 35° to 55°, or by 45°, with respect to an orientation direction of the liquid crystal layer 40 included in the electrically controlled birefringence mode liquid crystal panel.

Moreover, the light transmittance axis of the first polarizing plate 70 and the light transmittance axis of the second polarizing plate 80 have an angle from 80° to 100° with respect to each other.

In one embodiment, the light transmittance axis of the first polarizing plate 70 and the light transmittance axis of the second polarizing plate 80 are arranged orthogonal (90°) to each other.

Furthermore, in an embodiment of the present invention, the compensation film 90 is formed between the ECB mode liquid crystal panel and the first polarizing plate 70. Here, the negative retardation of the compensation film 90 ranges from −60 nm to −10 nm. In one embodiment, the negative retardation of the compensation film 90 is −35 nm.

When the compensation film is the optical viewing angle compensation film, an optical axis thereof is inclined by −10° to 10° with respect to an orientation direction of the liquid crystal layer 40 included in the ECB mode liquid crystal panel, and, in one embodiment, the optical axis of the optical viewing angle compensation film is horizontal to the orientation direction of the liquid crystal layer 40. When the compensation film is the retardation film, an optical axis thereof is inclined by 80° to 100° with respect to an orientation direction of the liquid crystal layer 40 included in the electrically controlled birefringence mode liquid crystal panel, and, in one embodiment, the optical axis of the retardation film is orthogonal to the orientation direction of the liquid crystal layer 40.

Accordingly, an optical axis of the compensation film 90 and a light transmittance axis of the first polarizing plate 70 facing the compensation film 90 are arranged to have an angle from 35° to 55° with respect to each other.

Further, in one embodiment, the optical axis of the compensation film 90 and the light transmittance axis of the first polarizing plate 70 facing the compensation film 90 are arranged to have an angle of 45° with respect to each other.

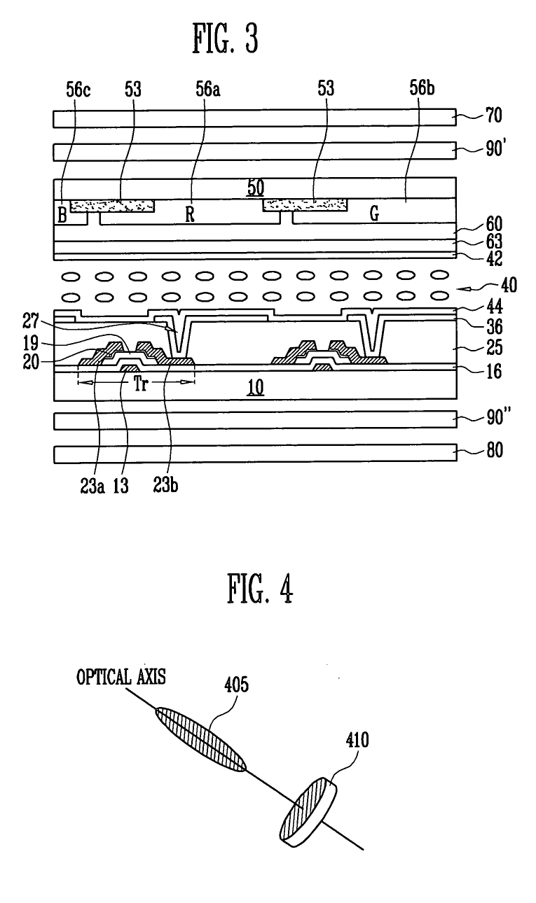

FIG. 3 is a cross-sectional view showing a liquid crystal display device according to another embodiment of the present invention. There may be parts shown in FIG. 3, or parts not shown in FIG. 3, that are not discussed below as they are not essential to a complete understanding of the invention. Like reference numerals in FIG. 3 designate like elements in FIG. 2.

Upon comparing the embodiment of the present invention shown in FIG. 3 with the embodiment of FIG. 2, a first compensation film 90′ is disposed between the first polarizing plate 70 and a liquid crystal panel, and a second compensation film 90″ is disposed between the second polarizing plate 80 and a liquid crystal panel.

Accordingly, each of the first and second compensation films 90′ and 90″ can be composed of an optical viewing angle compensation film or a retardation film. The negative retardation of each of the first and second compensation films 90′ and 90″ ranges from −60 nm to −10 nm, or, in one embodiment, is −35 nm.

In addition, when the compensation film is the optical viewing angle compensation film, an optical axis thereof is inclined by −10° to 10° with respect to an orientation direction of the liquid crystal layer 40 included in the ECB mode liquid crystal panel, and, in one embodiment, the optical axis of the optical viewing angle compensation film is horizontal to the orientation direction of the liquid crystal layer 40. When the compensation film is the retardation film, an optical axis thereof is inclined by 80° to 100° with respect to an orientation direction of the liquid crystal layer 40 included in the electrically controlled birefringence mode liquid crystal panel, and, in one embodiment, the optical axis of the retardation film is orthogonal to the orientation direction of the liquid crystal layer 40.

Accordingly, an optical axis of the first compensation film 90′ and a light transmittance axis of the first polarizing plate 70 facing the first compensation film 90′ and/or an optical axis of the second compensation film 90″ and a light transmittance axis of the second polarizing plate 80 facing the second compensation film 90″ are arranged to have an angle from 35° to 55° with respect to each other.

Further, in one embodiment, the optical axis of the first compensation film 90′ and the light transmittance axis of the first polarizing plate 70 facing the first compensation film 90′ and/or the optical axis of the second compensation film 90″ and the light transmittance axis of the second polarizing plate 80 facing the second compensation film 90″ are arranged to form an angle of 45° with respect to each other.

FIG. 4 is a view showing an internal construction of an optical viewing angle compensation film included in a liquid crystal display device according to an embodiment of the present invention. The embodiment of FIG. 4 is to be regarded as illustrative in nature, rather than restrictive, and the present invention is not thereby limited.

Referring to FIG. 4, in the interior structure of the optical viewing angle compensation film according to the embodiment of the present invention, an optical axis of a nematic liquid crystal molecule 405 and a discotic liquid crystal molecule 410 are identically arranged. As such, to some extent, this may compensate a variation of the retardation with respect to a moving direction of a light that has permeated the ECB mode liquid crystal panel.

Moreover, the nematic liquid crystal molecule 405 is a positive uniaxial material. An extraordinary refractive index nₑ of the nematic liquid crystal molecule 405 is greater than an ordinary refractive index n₀ thereof. In contrast to this, the discotic liquid crystal molecule 410 is a negative uniaxial material. An extraordinary refractive index nₑ of the nematic liquid crystal molecule 410 is less than an ordinary refractive index n₀ thereof.

According to the present invention, by attaching first and second polarizing plates to upper and lower sides of the ECB mode liquid crystal panel, and forming an optical viewing angle compensation film between the first and/or second polarizing plates, an occurrence of a remaining retardation in an ECB mode liquid crystal panel is prevented to improve a contrast and a viewing angle.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A liquid crystal display device comprising:
an electrically controlled birefringence mode liquid crystal panel for driving a liquid crystal cell and including first and second substrates, first and second orientation films respectively being at the first and second substrates and oriented opposite to each other, and a liquid crystal layer formed between the first and second substrates;
a first polarizing plate formed at an outer surface of the first substrate;
a second polarizing plate formed at an outer surface of the second substrate; and
a compensation film formed between the electrically controlled birefringence mode liquid crystal panel and the first polarizing plate, and/or between the electrically controlled birefringence mode liquid crystal panel and the second polarizing plate.

2. The liquid crystal display device according to claim 1, wherein the compensation film is composed of an optical viewing angle compensation film or a retardation film.

3. The liquid crystal display device according to claim 1, wherein the second substrate includes:
a thin film transistor including a gate electrode and a drain electrode;
a passivation layer formed at an upper portion of the thin film transistor, and having a contact hole to expose the drain electrode; and
a pixel electrode formed at an upper portion of the passivation layer and connected to the drain electrode through the contact hole.

4. The liquid crystal display device according to claim 1, wherein the first substrate includes:
black matrixes formed at a location corresponding to the thin film transistor formed at the second substrate;
a color filter pattern having red, green, and blue filters arranged repeatedly between the black matrixes; and
an overcoat layer and a common electrode sequentially formed on the color filter pattern.

5. The liquid crystal display device according to claim 1, wherein the first substrate includes:
a black matrix formed at a location corresponding to the thin film transistor formed at the second substrate;
a color filter pattern having first and second color filters arranged to have the black matrix between the first and second color filters; and
an overcoat layer and a common electrode sequentially formed on the color filter pattern.

6. The liquid crystal display device according to claim 1, further comprising a backlight installed at a lower portion of the second polarizing plate.

7. The liquid crystal display device according to claim 1, wherein a light transmittance axis of the first polarizing plate and a light transmittance axis of the second polarizing plate are inclined by about 35° to 55° with respect to an orientation direction of the liquid crystal layer included in the electrically controlled birefringence mode liquid crystal panel.

8. The liquid crystal display device according to claim 7, wherein the light transmittance axis of the first polarizing plate and the light transmittance axis of the second polarizing plate are inclined by about 45° with respect to the orientation direction of the liquid crystal layer included in the electrically controlled birefringence mode liquid crystal panel.

9. The liquid crystal display device according to claim 1, wherein a light transmittance axis of the first polarizing plate and a light transmittance axis of the second polarizing plate have an angle from about 80° to 100° with respect to each other.

10. The liquid crystal display device according to claim 9, wherein the light transmittance axis of the first polarizing plate and the light transmittance axis of the second polarizing plate are arranged orthogonal to each other.

11. The liquid crystal display device according to claim 1, wherein the compensation film has a negative retardation.

12. The liquid crystal display device according to claim 11, wherein the negative retardation of the compensation film ranges from about −60 nm to −10 nm.

13. The liquid crystal display device according to claim 12, wherein the negative retardation of the compensation film is about −35 nm.

14. The liquid crystal display device according to claim 2, wherein an optical axis of the optical viewing angle compensation film is inclined by about −10° to 10° with respect to an orientation direction of the liquid crystal layer included in the electrically controlled birefringence mode liquid crystal panel.

15. The liquid crystal display device according to claim 14, wherein the optical axis of the optical viewing angle compensation film is arranged horizontal to the orientation direction of the liquid crystal layer included in the electrically controlled birefringence mode liquid crystal panel.

16. The liquid crystal display device according to claim 2, wherein an optical axis of the retardation film is inclined by about 80° to 100° with respect to an orientation direction of the liquid crystal layer included in the electrically controlled birefringence mode liquid crystal panel.

17. The liquid crystal display device according to claim 16, wherein the optical axis of the retardation film is arranged orthogonal to the orientation direction of the liquid crystal layer included in the electrically controlled birefringence mode liquid crystal panel.

18. The liquid crystal display device according to claim 1, wherein an optical axis of the compensation film and a light transmittance axis of the first and/or second polarizing plate facing the compensation film are arranged to have an angle from about 35° to 55° with respect to each other.

19. The liquid crystal display device according to claim 18, wherein the optical axis of the compensation film and the light transmittance axis of the first and/or second polarizing plate facing the compensation film are arranged to have an angle of about 45° with respect to each other.

20. A liquid crystal display device comprising:
an electrically controlled birefringence mode liquid crystal panel including first and second substrates, first and second orientation films respectively being at the first and second substrates and oriented opposite to each other, and a liquid crystal layer formed between the first and second substrates;
a first polarizing plate formed at an outer surface of the first substrate;
a second polarizing plate formed at an outer surface of the second substrate; and
a compensation film formed between the electrically controlled birefringence mode liquid crystal panel and the first polarizing plate.
